(19) United States
(12) Patent Application Publication
(10) Pub. No.: US 2011/0093396 A1
(43) Pub. Date: Apr. 21, 2011

(54) SYSTEM AND METHOD FOR FLEXIBLE METERING AND PAYMENT FOR POWER USAGE

(75) Inventors: Arthur J. PARKOS, Southbury, CT (US); Maria Paz PARKOS, Southbury, CT (US); Yassir NAWAZ, Hamden, CT (US); Øivind SANN, Heer (NO)

(73) Assignee: Pitney Bowes Inc., Stamford, CT (US)

(21) Appl. No.: 12/580,433

(22) Filed: Oct. 16, 2009

(51) Int. Cl. G06Q 50/00; G06Q 10/00; G06Q 30/00; H04L 9/28; G06Q 20/00; H04L 9/30

(52) U.S. Cl. 705/63; 705/412; 705/34; 713/176; 380/277

(57) ABSTRACT

According to some embodiments, a power meter comprises an interface for a connection between a power outlet and a motor vehicle battery. A power measuring circuit may be coupled to the interface. A processor may be coupled to the power measuring circuit. The motor vehicle battery is installed in a motor vehicle. The power meter may be configured for installation in the motor vehicle. Furthermore, a computer-readable medium may be in communication with the processor and may store program instructions. The processor may be operative with the program instructions to receive identification information associated with the power outlet, record a measurement of an amount of electricity received by the motor vehicle battery from the power outlet during a charging transaction, and generate a receipt associated with the charging transaction. The identification information identifies an owner of the power outlet. The receipt may be for facilitating compensation to the owner of the power outlet for the charging transaction and the receipt may include information for identifying the owner of the power outlet.

### BACKGROUND OF THE INVENTION

A greater number of battery powered motor vehicles are being driven than have been in previous years. Typically, an owner of an electric vehicle will charge his electric motor vehicle at home before driving to his destination. By charging his electric motor vehicle at home, the owner of the electric motor vehicle will be billed by his electric utility company for the power used to charge his battery powered motor vehicle.

While battery powered motor vehicles are usually charged at home, owners of the battery powered motor vehicles may want to be able to charge their vehicle at any convenient location such as a friend's house, a business that is frequented, or at a parking space in front of a store.

Most of these locations may already have power outlets in which the owner of the power outlet is billed for usage. However, these locations lack a mechanism for the owner of the power outlet to be reimbursed for an amount of electricity used to charge a battery powered motor vehicle that belongs to a third party.

### SUMMARY

Generally, a power meter comprises an interface for a connection between a power outlet and a motor vehicle battery. A power measuring circuit may be coupled to the interface. A processor may be coupled to the power measuring circuit. The motor vehicle battery is installed in a motor vehicle. The power meter may be configured for installation in the motor vehicle. Furthermore, a computer-readable medium may be in communication with the processor and may store program instructions. The processor may be operative with the program instructions to receive identification information associated with the power outlet, record a measurement of an amount of electricity received by the motor vehicle battery from the power outlet during a charging transaction, and generate a receipt associated with the charging transaction. The identification information identifies an owner of the power outlet. The receipt may be for facilitating compensation to the owner of the power outlet for the charging transaction and the receipt may include information for identifying the owner of the power outlet.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, descriptions, and claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a system according to some embodiments.

FIG. 2 illustrates a method according to some embodiments.

FIG. 3 illustrates a method according to some embodiments.

FIG. 4 illustrates a method according to some embodiments.

FIG. 5 illustrates a method according to some embodiments.

FIG. 6 illustrates a power meter according to some embodiments.

### DETAILED DESCRIPTION

The several embodiments described herein are provided solely for the purpose of illustration. Embodiments may include any currently or hereafter-known versions of the elements described herein. Therefore, persons in the art will recognize from this description that other embodiments may be practiced with various modifications and alterations.

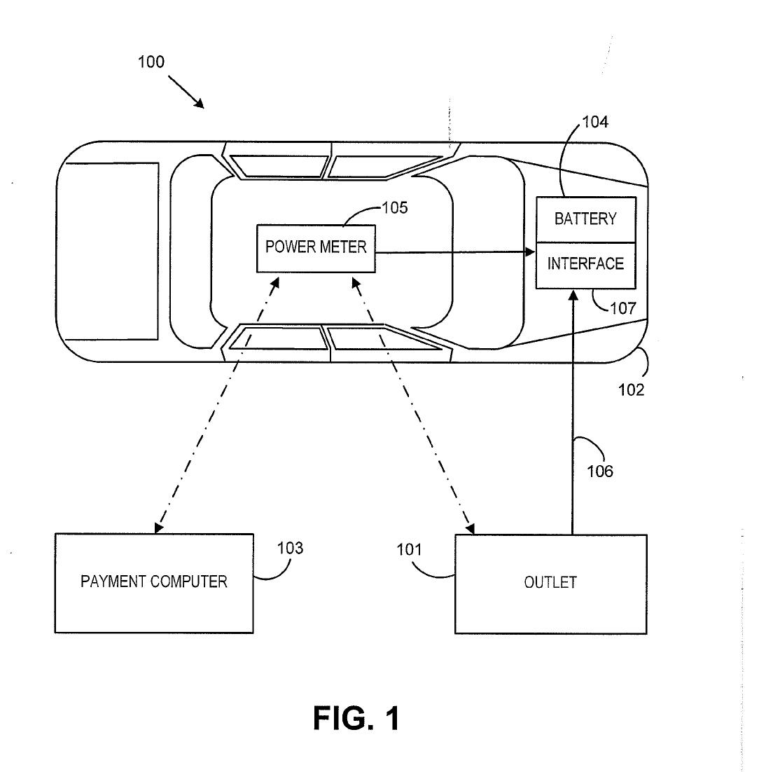

Now referring to FIG. 1, an embodiment of a system 100 is illustrated. The system may comprise a power outlet 101, a motor vehicle 102, and a payment computer 103.

The power outlet 101 may comprise any conventional power outlet, such as, but not limited to, a 110V power outlet, a 230V power outlet, or a 220V power outlet. In some embodiments, the power outlet may comprise memory to store identification information associated with the power outlet and a communication device to transmit the identification information. The identification information may identify a specific outlet, an owner of the outlet, or an account associated with the outlet. In some embodiments, an identification device may be coupled to the power outlet to provide the identification information.

In some embodiments, the motor vehicle 102 may comprise a battery powered motor vehicle, a hybrid-electric motor vehicle, or any conventional motor vehicle in which a battery may be charged via a power outlet. The motor vehicle 102 may comprise a battery 104 and a power meter 105. The power meter 105 may be coupled to the battery 104 to determine an amount of electricity that the battery 104 receives from the power outlet 101 during a charging transaction where a charging transaction may be defined as an occasion in which a battery receives power form an outlet. In some embodiments, the motor vehicle 102 may comprise a plug (not shown) to electrically couple a cable 106 to the motor vehicle 102. In some embodiments, the power meter 105 may comprise an interface 107 to couple the power meter to the battery 104.

The battery may comprise a nickel-metal hydride battery (Ni-MH), a lithium-ion battery, or any battery that may be used in a motor vehicle. In some embodiments, the battery may be electrically coupled to the power outlet 101 via a cable 106. However, in other embodiments, the cable 106 may connect directly to the battery 104. In yet another embodiment, the power meter 105 may communicate with the power outlet 101 through the cable 106.

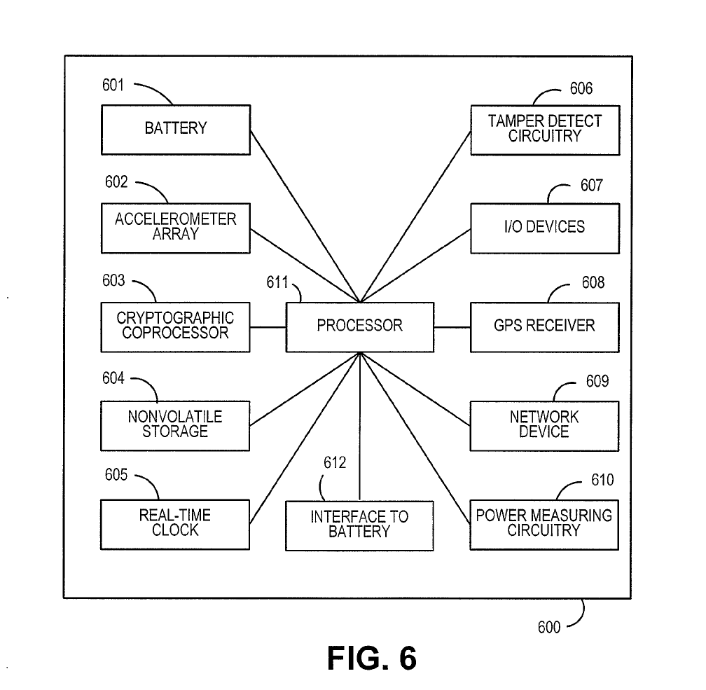

The power meter 105 may be installed in the motor vehicle 102. In some embodiments, the power meter 105 may be a standalone (i.e., portable) meter that interfaces with the motor vehicle 102. The power meter 105 may communicate with the payment computer 103 and/or the power outlet 101. In some embodiments, the power meter 105 may communicate with the payment computer 103 through a wireless network, such as, but not limited to, a Bluetooth network, or an IEEE 802.11 based network. In some embodiments, the power meter 105 may communicate with the payment computer 103 via an input/output device such as input/output device 607 of FIG. 6. In yet another embodiment, the power meter 105 may download data directly to the payment computer through the input/output device 607.

The payment computer 103 may be associated with an electric utility, a payment service provider, a power meter provider, or an owner of the power outlet. The payment computer 103 may comprise any computer, computer system, or printer that may facilitate compensation to an owner of the power outlet 101 for power received by the battery 104 during a charging transaction. In an embodiment in which the payment computer 103 comprises a printer, the power meter 105 may transmit information to the printer to output a printed receipt. In an embodiment in which the payment computer 103 comprises a computer system, the power meter 105 may transmit information that is input into a billing program or any other program hosted on the payment computer 103. In some embodiments, the payment computer 103 may be located in close proximity to the power outlet 101 and the payment computer 103 may transfer a receipt to a power meter provider/electric utility. In some embodiments, the payment computer 103 may be located at a power meter provider/electric utility to verify a digital signature associated with the receipt and to authorize funds to an owner of the power outlet 101.

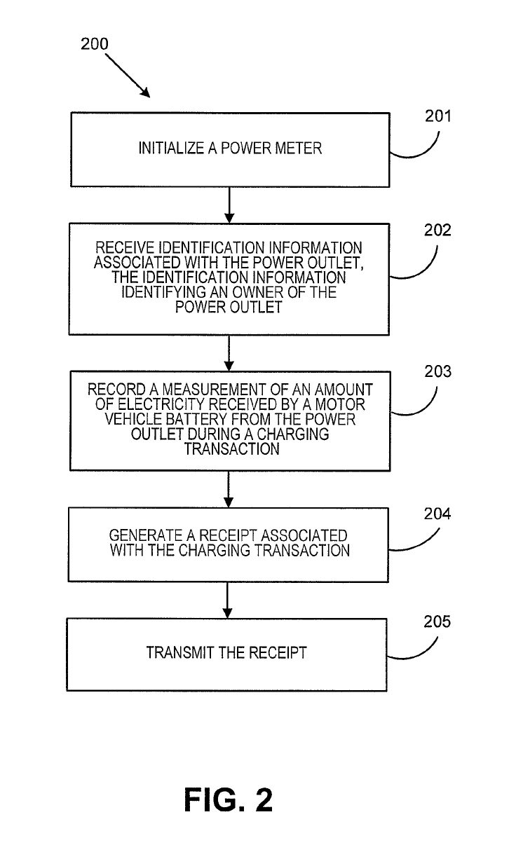

Now referring to FIG. 2, an embodiment of a method 200 is illustrated. Method 200 may be performed by a system, such as system 100 of FIG. 1. At 201, a power meter is initialized. In some embodiments, initialization may comprise generating and storing, either a secret or a public/private cryptographic key pair in persistent memory located on the power meter. The generated cryptographic key may be securely stored in a meter provider's database to verify future messages from the meter. In some embodiments the meter provider may also generate and store a digital certificate for the meter's public key in the meter's persistent memory. In some embodiments, initializing a power meter may comprise associating a prepaid amount of money with the power meter. In yet another embodiment, initialization may comprise assigning a unique identification to the power meter.

Next, at 202, identification information associated with the power outlet may be received by the power meter from the power outlet or a device associated therewith. Communication between the power meter and the outlet may be via Bluetooth or any conventional wireless communication standard. The identification information may identify an owner of the power outlet. For example, the identification information may comprise, but is not limited to, a location of the power outlet, an account number associated with the power outlet, or a name of the power outlet owner. In some embodiments, the identification information that identifies a location of the power outlet may comprise global positioning satellite (“GPS”) information received via a GPS receiver. The identification information that may be received directly from a local computer network, may comprise information such as, but not limited to, an IP address, or an electronic file that comprises an account number associated with a utility company that provides power to the power outlet. In some embodiments, the identification information may be manually entered into the power meter. In yet another embodiment, the identification information may be received via the cable 106. In some embodiments the identification information may be encrypted.

A measurement of an amount of electricity received by the motor vehicle battery from the power outlet is recorded during a charging transaction at 203. The measurement may be recorded by the power meter and stored in memory.

In some embodiments, the power meter may store a current market rate for electricity (e.g., price per kilowatt). In this embodiment, the power meter may calculate a cost for the amount of electricity received by the motor vehicle battery from the power outlet. In another embodiment, the power meter may receive a current market rate for electricity when it establishes communication with a payment computer.

Next, at 204, a receipt associated with the charging transaction is generated. The receipt may comprise a paper receipt, an electronic file, or a stream of digital data. The receipt may comprise one or more of a date, a time, a meter identification, an amount of power received during a changing transaction, an indication of an owner of the power outlet, a GPS location of the outlet, a customers power meter provider number, a cryptographic digital signature associated with the critical information contained in the receipt that is computed by using a private or secret key that is stored in the meter during its initialization as described above, identification information associated with the power outlet, information indicative of a calculated cost of the amount of power received, as well as other information associated with the power meter.

At 205, the receipt may be transmitted. In some embodiments, the receipt may be transmitted to a payment computer to facilitate compensation to an owner of the power outlet. In some embodiments, the power meter may transmit the receipt through a wireless network, an input/output device or via cellular communication.

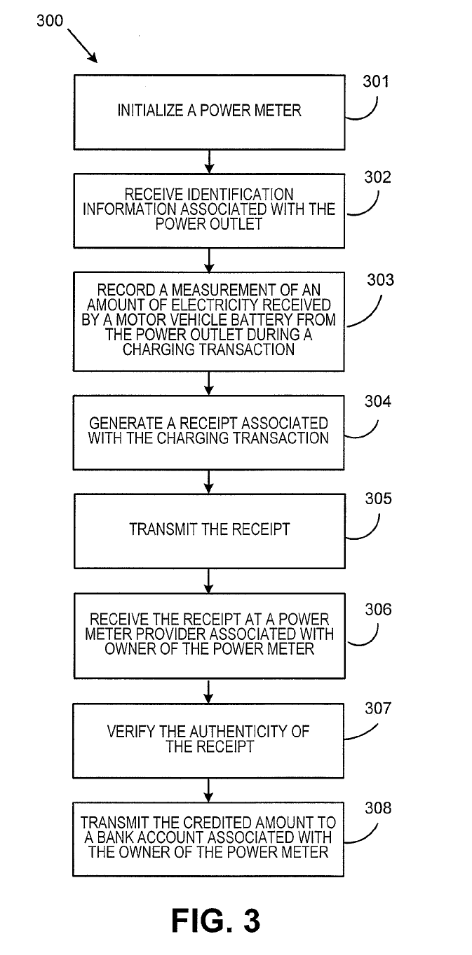

Now referring to FIG. 3, an embodiment of a method 300 is illustrated. In the present embodiment, a motor vehicle owner may buy or rent a power meter from a power meter provider. The power meter provider may create a customer account associated with the motor vehicle owner and the motor vehicle owner may setup a billing arrangement with the power meter provider. For example, the billing arrangement may comprise a pre-payment plan that may allow a meter to be refilled (i.e., more money added to the meter), or an automatic payment plan associated with a credit card or a bank account.

Elements 301, 302, 303, 304, and 305 of FIG. 3 correspond, respectively, to previously described elements 201 through 205 of FIG. 2.

Now referring to 306, a receipt is received at a power meter provider associated with an owner of a power meter. In some embodiments, the owner of the power meter may be the power meter provider and an owner of a motor vehicle may rent the power meter from the power meter provider.

At 307, the power meter provider may verify the authenticity of the receipt. For example, the power meter provider may verify the authentic of the receipt by verifying the digital signature associated with the receipt. In some embodiments, the meter provider may possess a meter's public or secret key in its database. This key may be used to verify the signature in the receipt. In some embodiments a digital certificate may be provided by a meter along with a receipt to the meter provider. The public key of the meter may be obtained from the digital certificate and used for signature verification. If the digital signature in the receipt is not determined to be authentic then the receipt may be rejected. However if the digital receipt is considered genuine, then processing continues at 308. In some embodiments, additional verification steps associated with information included in the receipt may be taken. For example, a determination may be made if the owner of the power meter has an account with the power meter provider.

If the verification determines that the digital signature belongs to the power meter, then at 308 a credited amount is forwarded to the owner of the power outlet. For example, the credited amount may be transmitted to a bank account associated with the owner of the power outlet. In some embodiments, the power meter provider may forward a check or wire transfer money to the owner of the power outlet. In some embodiments, the credited amount may be subtracted from an account associated with the owner of the power meter and added to an account associated with the owner of the motor vehicle. Some embodiments of the present application allow anyone with a power outlet to be able to be reimbursed for costs when providing power to motor vehicles.

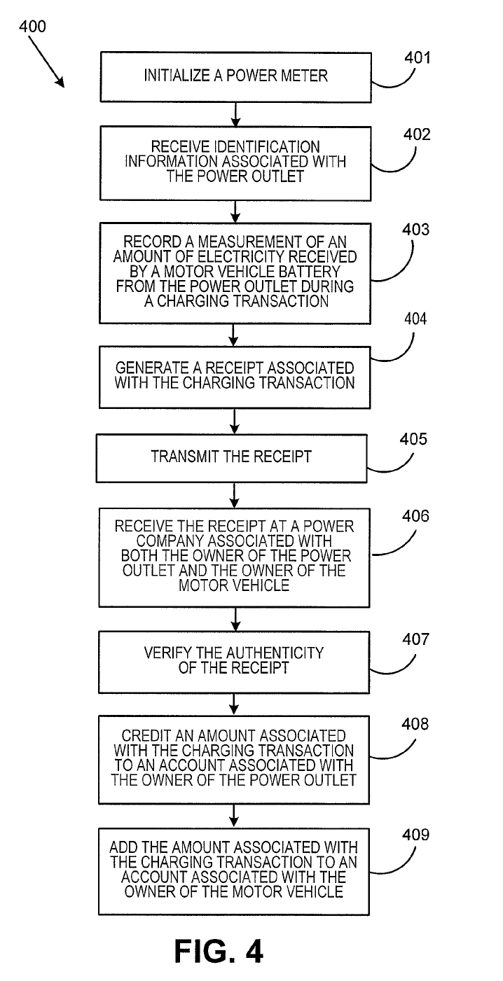

Now referring to FIG. 4, an embodiment of a method 400 is illustrated. In this embodiment, a vehicle owner may buy/rent a power meter from an electric utility (i.e., a provider of electricity) or from a third party that is affiliated with the electric utility. The vehicle owner may open a customer account with the electric utility where the electric utility provides power to an owner of a power outlet.

Elements 401, 402, 403, 404, and 405 of FIG. 4 correspond, respectively, to previously described elements 201 through 205 of FIG. 2.

At 406, a receipt is received at an electric utility where the electric utility is associated with both the owner of the power outlet and the owner of the motor vehicle.

Next, at 407 the electric utility may verify a digital signature associated with the receipt. In some embodiments, the electric utility may utilize a third party to verify the digital signature. In this embodiment, the third party may transmit receipts to the electric utility for payment if the digital signature of the receipt is considered genuine.

If the verification determines that the digital signature belongs to the power meter, then, at 408 an amount associated with the charging transaction may be credited to an account associated with the owner of the power outlet. In this embodiment, since both the owner of the power outlet and the owner of the motor vehicle are associated with the same electric utility, the electric utility may just credit the account associated with the power outlet for an amount associated with the power used by the owner of the motor vehicle. Next, the amount associated with the charging transaction is added to an account associated with the owner of the motor vehicle at 409. In an embodiment in which a pre-paid plan is used, the amount associated with the charging transaction may be deducted from a pre-payment amount of money stored in the power meter.

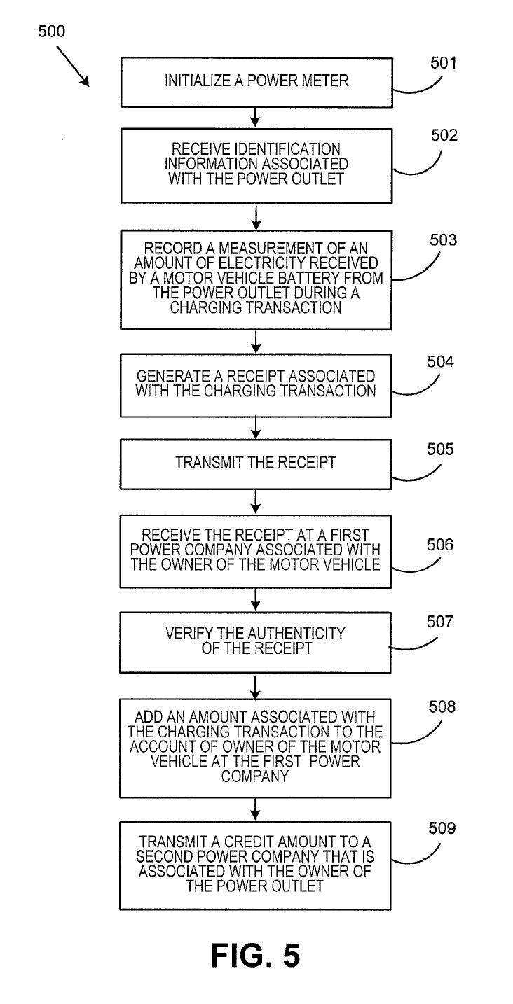

Now referring to FIG. 5, an embodiment of a method 500 is illustrated. In this embodiment, a vehicle owner may open a customer account with a first electric utility that is a different company than a second electric utility which provides power to a power outlet.

Elements 501, 502, 503, 504, and 505 of FIG. 5 correspond, respectively, to previously described elements 201 through 205 of FIG. 2.

At 506, a receipt is received at a first electric utility associated with the owner of the motor vehicle. Next, at 507 the first electric utility may verify a digital signature associated with the receipt.

If the verification determines that the digital signature is genuine then, at 508, an amount associated with a charging transaction is added to the account of the owner of the motor vehicle at the first electric utility.

Next, at 509 a credit amount is transmitted to a second electric utility company that is associated with the owner of the power outlet. The second electric utility company may then credit the account associated with the owner of the power outlet.

Now referring to FIG. 6, an embodiment of a power meter 600 is illustrated. The power meter 600 may comprise an internal battery 601, an accelerometer array 602, a cryptographic processor 603, nonvolatile storage 604, a real-time clock 606, a tamper detect circuitry 606, one or more input/output devices 607, a GPS receiver 608, a network device 609, power measuring circuitry 610, a processor 611, and an interface 612.

The internal battery may comprise any battery that is, or will be known. The battery may provide power to the various components of the power meter 600. In some embodiments, the power meter 600 may utilize power from an external battery such as battery 104 of FIG. 1.

The accelerometer array 602 may be used in conjunction with the GPS receiver 608 to determine a position of the power meter 600. The accelerometer array 602 and GPS receiver 608 may be any accelerometer array 602 and GPS receiver 608 that is, or will be known.

The cryptographic co-processor may comprise a processor to perform cryptographic operations including generating cryptographic keys and generating cryptographic digital signatures. In some embodiments, the cryptographic co-processor 603 may be used to facilitate secure communication between the power meter 600 and a payment computer.

The nonvolatile storage 604 may comprise computer memory that can retain stored information when not powered. For example, the non-volatile storage may comprise, but is not limited to, read-only memory, flash memory, a hard drive, or an optical disc. The nonvolatile storage 604 may comprise a computer-readable medium. The computer-readable medium may be in communication with the processor 611 and may store program instructions that when executed by the processor 611 perform a method.

The real-time clock 605 may provide a clocking source for the power meter 600. The tamper detect circuitry 606 may be used to prevent tampering to the power meter 600. In some embodiments the tamper detect circuitry 606 may disable the power meter from operating if the tamper detect circuitry 606 detects that the power meter has been opened. In some embodiments, the tamper detect circuitry 606 may be used to secure an indication of a prepaid amount of money that is stored within the power meter 600.

The I/O devices 607 may comprise an interface to the power meter for inputting and outputting such as, but not limited, to a universal serial bus (“USB”) port, a keyboard, an LCD display, and/or a touch screen display. The network device 609 may comprise a communication interface such as, but not limited to, a cellular transmitter/receiver, an 802.11 based network, Wi-Fi, Blue Tooth, NFC, or a power line modem. The network device 609 may be used to communicate with a payment computer and/or a power outlet.

The power measuring circuitry 610 may be electrically coupled to a motor vehicle battery to measure an amount of power received by the motor vehicle battery. The power measuring circuitry 610 may measure power in watts.

The interface 612 may facilitate coupling of a car battery to the power meter. In some embodiments, the interface 612 may comprise one or more plugs to receive one or more cables. In some embodiments, a cable, such as cable 106 may also be plugged into the interface to provide power to a car battery. The interface 612 may be internal to the power meter 600 or may be external to the power meter 600.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A power meter comprising:
an interface for connection between a power outlet and a battery;
a power measuring circuit coupled to the interface;
a processor coupled to the power measuring circuit;
a computer-readable medium in communication with the processor and storing program instructions, the processor operative with the program instructions to:
receive identification information associated with the power outlet, the identification information identifying an owner of the power outlet;
record a measurement of an amount of electricity received by the motor vehicle battery from the power outlet during a charging transaction; and
generate a receipt associated with the charging transaction, the receipt for facilitating compensation to the owner of the power outlet for the charging transaction, the receipt including information for identifying the owner of the power outlet.

2. The power meter according to claim 1, wherein the receipt includes a digital signature generated by the processor.

3. The power meter according to claim 2, wherein the digital signature is associated with information contained in the receipt and is computed by using a private key stored in the power meter.

4. The power meter according to claim 1, wherein the processor is further operative with the program instructions to:
calculate a cost for the amount of electricity received by the battery from the power outlet, wherein the receipt includes information indicative of the calculated cost.

5. The power meter according to claim 1, wherein the processor is further operative with the program instructions to:
electronically transmit the receipt to a third party.

6. The power meter according to claim 5, wherein the third party is an electric utility that supplies power to the owner of the power outlet.

7. The power meter according to claim 5, wherein the third party is a payment service company.

8. The power meter according to claim 1, wherein the processor is further operative with the program instructions to:
electronically transmit the receipt to a computer operated by or on behalf of the owner of the power outlet.

9. The power meter according to claim 1, wherein the power meter is configured for installation in a motor vehicle and the battery is installed in the motor vehicle.

10. The power meter according to claim 1, wherein the processor is further operative with the program instructions to initialize the power meter by generating and storing a public/private cryptographic key pair.

11. The power meter according to claim 1, wherein the received identification information comprises an IP address or an account number associated with a utility company that provides power to the power outlet.

12. The power meter according to claim 1, wherein the processor is further operative with the program instructions to:
transfer the receipt to at least one electric utility;
subtract an amount associated with the receipt from an account associated with the owner of the power outlet; and
add the amount associated with the receipt to an account associated with an owner of the battery.

13. A method comprising:
receiving identification information from a power outlet, the identification information identifying an owner of the power outlet;
recording a measurement of an amount of electricity received by a battery from the power outlet during a charging transaction; and
generating a receipt associated with the charging transaction, the receipt for facilitating compensation to the owner of the power outlet for the charging transaction, the receipt including information for identifying the owner of the power outlet.

14. The method according to claim 13, wherein the receipt includes a digital signature generated by the processor.

15. The method according to claim 14, wherein the digital signature identifies a power meter that generated the receipt.

16. The method according to claim 14, wherein the digital signature is associated with information contained in the receipt and is computed by using a private key that is stored in the power meter.

17. The method according to claim 13, further comprising:
initializing the power meter by generating and storing a public/private cryptographic key pair.

18. The method according to claim 13 wherein the received identification information comprises an IP address or an account number associated with a utility company that provides power to the power outlet.

19. The method according to claim 13, further comprising:
electronically transmitting the receipt to a third party.

20. The method according to claim 19, wherein the third party is an electric utility that supplies power to the owner of the power outlet.

21. The method according to claim 19, wherein the third party is a payment service company.

22. The method according to claim 13, further comprising:
calculating a cost for the amount of electricity received by the battery from the power outlet, wherein the receipt includes information indicative of the calculated cost.

23. The method according to claim 13, further comprising:
electronically transmitting the receipt to a computer operated by or on behalf of the owner of the power outlet.

24. The method according to claim 13, further comprising:
transferring the receipt to at least one electric utility;
subtracting an amount associated with the receipt from an account associated with the owner of the power outlet; and
adding the amount associated with the receipt to an account associated with an owner of the battery.
